(19) United States
(12) Patent Application Publication
(10) Pub. No.: US 2004/0141436 A1
(43) Pub. Date: Jul. 22, 2004

(54) Recording device with independently movable read and write heads

(76) Inventor: Andrew R. Monahan, Silver Spring, MD (US)

Correspondence Address: Joseph V. Gamberdell, Jr., PERMAN & GREEN, LLP, 425 Post Road, Fairfield, CT, 06824, US

(21) Appl. No.: 10/346,776

(22) Filed: Jan. 17, 2003

(51) Int. Cl. G11B 7/00

(52) U.S. Cl. 369/47.24; 369/47.3

(57) ABSTRACT

A recording device includes a write head adapted to record an electronic data stream on a recording medium and a read head adapted to read the electronic data stream from the recording medium. The read head is selectively and independently positionable on the recording medium relative to the write head. The read head may be adapted to selectively read previously recorded portions of the electronic data stream from the recording medium simultaneously while the write head records the electronic data stream on the recording medium in real time.

### BACKGROUND OF THE INVENTION

1. Field of the Invention

The present invention relates to recording devices for recording electronic data on recording media and, more particularly, to recording devices with independently movable read and write heads.

2. Prior Art

Consumers have been able to record audio and video program material for playback at a convenient time for some time using for example, audio and video cassette recorders. These devices allow a user to record and later view audio and video program material, such as music, TV programs, and movies. PVR (personal video recorders) products have been introduced which store program material in a form that allows random access, for example, on a conventional computer hard drive. This allows a user to quickly jump to a particular portion of the program material. In addition, as program material is being recorded real time, it may be paused and then resumed. The paused material may be resumed in a delayed mode, or may be fast-forwarded to catch up to real-time.

It would be desirable to provide an information storage device with independent recording and playback capability features in addition to those presently available in conventional audio and video recorders.

### SUMMARY OF THE INVENTION

In a first embodiment of the invention, a recording device includes a write head adapted to record an electronic data stream on a recording medium and a read head adapted to read the electronic data stream from the recording medium. The read head is selectively and independently positionable on the recording medium relative to the write head. In addition, the read head is adapted to selectively read previously recorded portions of the electronic data stream from the recording medium simultaneously while the write head records the electronic data stream on the recording medium in real time.

In a second embodiment of the invention, a recording device is adapted to record an input signal as electronic data on a rotating disk, where the recording device includes a first positioning drive, a write head coupled to the first positioning drive, a second positioning drive independently positionable relative to the first positioning drive, and a read head coupled to the second positioning drive. The read head is adapted to read data from the rotating disk simultaneously while the write head writes new data to the optical disk, and the second positioning device may selectively position the read head independent of the write head. In addition, the read head is adapted to track and read data written by the write head at a selectable delayed time interval from when the data was written to when the data is read.

A third embodiment of the invention includes a method of recording and playing an electronic data stream. The method includes writing data corresponding to the electronic data stream to a disk with a write head in substantially real time, following the write head with a read head being independently positionable relative to the write head, and selectively reading previously recorded portions of the electronic data stream with the read head simultaneously with the write head continuing to write data corresponding to the electronic data stream to the optical disk in substantially real time. The method further includes outputting data read by the read head at a rate substantially the same as the rate of the data being written.

### BRIEF DESCRIPTION OF THE DRAWINGS

The foregoing aspects and other features of the present invention are explained in the following description, taken in connection with the accompanying drawings, wherein:

FIG. 1 shows a schematic block diagram of a recording and playback system;

FIG. 2 shows a schematic block diagram of encoding circuitry;

FIG. 3 shows a schematic diagram of a write head;

FIG. 4 shows a schematic diagram of a read head;

FIG. 5 shows a schematic block diagram of decoding circuitry;

FIG. 6 shows a schematic block diagram of a system controller;

FIG. 7 shows a record mechanism, write head, playback mechanism, read head, and their operation.

FIG. 8 shows an embodiment of a recording mechanism and a playback mechanism; and

FIG. 9 shows another embodiment of a recording mechanism and a playback mechanism.

### DETAILED DESCRIPTION OF THE PREFERRED EMBODIMENT

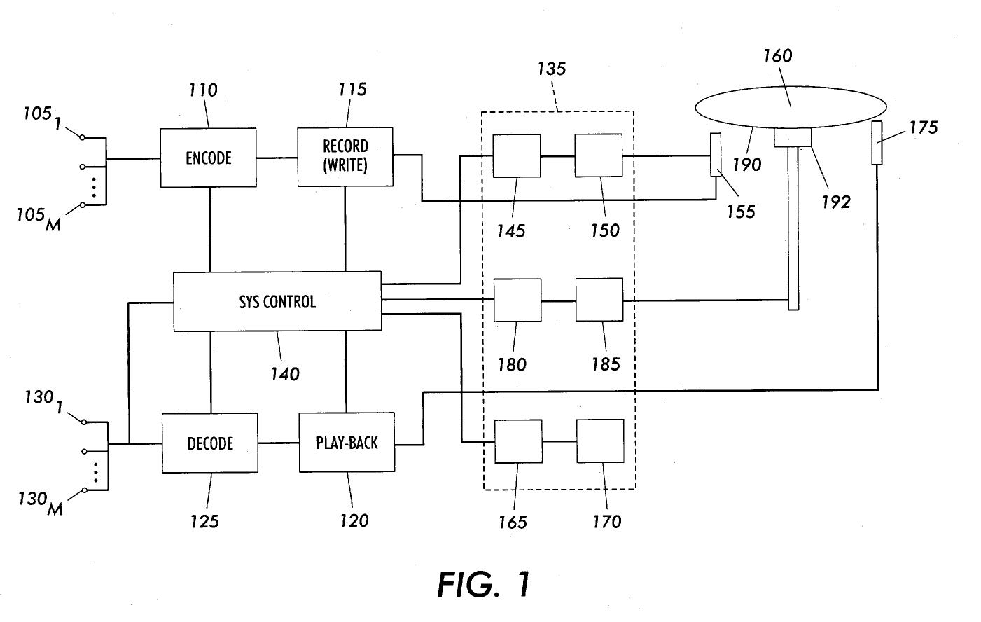

Referring to FIG. 1, there is shown a schematic block diagram of a recording and playback system 100 incorporating features of the present invention. Although the present invention will be described with reference to the embodiment shown in the drawings, it should be understood that the present invention can be embodied in many alternate forms of embodiments. In addition, any suitable size, shape or type of elements or materials could be used.

System 100 may include one or more inputs 100₁ . . . 105ₙ, encoding circuitry 110, recording circuitry 115, and a write head 155 for recording information on recording medium 160. System 100 may also include a read head 175 for reading information from recording medium 160, playback circuitry 120, decoding circuitry 125, and one or more outputs 130. System 100 may further include servo circuitry 135 and a system controller 140.

One or more inputs 105₁ . . . 105ₙ generally receive one or more information streams, also referred to as electronic data streams, which may comprise combined audio and video signals, or separate audio signal and video signals. The audio and video signals may be analog or digital signals, for example, signals from a television tuner, video camera, cable television system, satellite television system, etc., or may have any other form or combination of forms suitable for conveying audio and video, either as a combined signal or as separate signals. One or more inputs 105₁ . . . 105ₙ may be adapted to connect to any suitable connector, connection point, antenna, etc., for receiving audio and video signals. The one or more inputs 105₁ . . . 105ₙ may in turn be connected to encoding circuitry 110.

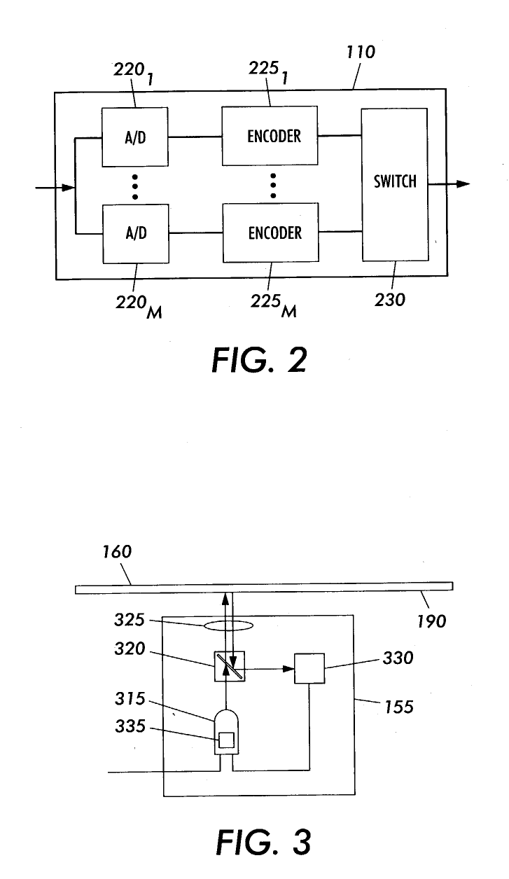

Turning now to FIG. 2, encoding circuitry 110 may include one or more analog to digital converters (A/D) 220₁ . . . 220ₙ, one or more encoders 225₁ . . . 225ₙ, and a switch 230. A/D's 220₁ . . . 220ₙ operate to convert the audio and video signals from inputs 105₁ . . . 105ₙ to a digital form. Where the audio and video signals are in digital form, A/D's 220₁ . . . 220ₙ may be bypassed and the audio and video signals may be directly to encoders 225₁ . . . 225ₙ. Encoders 225₁ . . . 225ₙ encode and/or compress the digitized video and audio signals to an encoded digital format, for example, MPEG-2, MPEG-3, AVI, MOV, or any suitable format for video encoding, or AAC, AC-3, PCM, or any suitable format for audio encoding. Individual ones of encoders 225₁ . . . 225ₙ, may encode the digitized audio and video signals using the same format, for example, MPEG-2 for video and AC-3 for audio, or may encode the digitized audio and video signals using different encoding formats, for example, encoder 225₁ may use MPEG-2 and AC-3, while encoder 225ₙ may use AVI and PCM. The encoded signals are then directed to switch 230. Switch 230 generally operates as a multiplexer, selecting one or more of the encoded signals to be connected to recording circuitry 115.

Recording circuitry 115 generally includes circuitry for processing the encoded audio and video signals for use by write head 155, and may include appropriate drivers, phase locked loop circuitry, amplifiers, level shifters, digital signal processors, microprocessors, analog to digital converters, digital to analog converters, memory, and various support circuitry. Recording circuitry 115 provides a record signal to write head 155.

Write head 155 generally operates to record information on recording medium 160. In the embodiment shown in FIG. 1, write head 155 is positioned below recording medium 160 for recording on a lower surface 190 of media 155. In other embodiments write head 155 may be positioned to record on an upper surface of recording medium 160.

Referring now to FIG. 3, write head 155 may include a radiation source 315, a beam splitter 320, a lens 325, and a detector 330. Radiation source 315 generates electromagnetic or photonic radiation, for example, a light beam, in response to the signal from recording circuitry 115. The radiation is directed to recording medium 160 through beam splitter 320 and lens 325 and causes a recording action on recording medium 160. The radiation may be reflected back through lens 325 to beam splitter 320 and directed to detector 330. Detector 330 may provide feedback to radiation source 315 regarding radiation intensity and the quality or efficacy of the recording action. Radiation source 315 may be, for example, a laser diode or any other suitable source of electromagnetic or photonic radiation for causing a recording operation on recording medium 160. Radiation source 315 may also employ a modulator 335, for example, an opto-acoustic or electro-optical modulator for the recording action. Radiation source 315 may also include any other components in any arrangement suitable for generating electromagnetic or photonic radiation to produce a recording action on recording medium 160.

Recording medium 160 is generally a device on which information, for example, data, audio, and/or video may be recorded and played back. Recording medium 160 may include a laser disk, optical disk, compact disk (CD), CD-ROM, digital video disk (DVD), magnetic disk, or any other device on which information may be recorded. In one embodiment, recording medium 160 is a reflective device on which information is recorded by altering the reflectivity of a portion of a surface. For example, a portion of lower surface 190, such that a certain amount of reflectivity is recognized as a digital “1” and another amount of reflectivity is recognized as a digital “0”.

Returning to FIG. 1, servo circuitry 135 may include a record servo 145 that operates a first positioning drive, also referred to as a record mechanism 150 in accordance with the teachings of the invention. Record mechanism 150 places or orients write head 155 with respect to recording medium 160, as will be described in detail below, for recording data onto recording medium 160. Record mechanism 150 may include a movable carriage or arm so that write head 155 may be moved relative to surface 190. For example, write head 155 may be movable to translate radially relative to a center of recording medium 160 or circumferentially around the center of recording medium 160. In particular, record mechanism 150 may move write head 155 from an inner diameter of recording medium 160 to an outer diameter of recording medium 160 while write head 155 records information onto recording medium 160.

Servo circuitry 135 may also include a playback servo 165 that operates a second positioning drive, also referred to as a reading mechanism 170 in accordance with the teachings of the invention. Reading mechanism 170 places or orients read head 175 with respect to recording medium 160, as will be described in detail below, for reading data from recording medium 160. Servo circuitry 135 may also include a spindle servo 185 for controlling a spindle motor 185. Spindle motor 185 is coupled to a shaft 187 which drives a media chuck or support 192. Media support 192 includes an appropriate mechanism for holding recording medium 160 as media support 192 is rotated by spindle motor 185 utilizing shaft 187. Spindle servo 180 may be operable to control spindle motor 185 to rotate media support 192 and recording medium 160 at constant or variable speeds. For example, spindle servo 180 may operate to rotate recording medium 160 so as to maintain a constant linear velocity with respect to surface 190, varying the rotational speed of recording medium 160 depending on the location of write head 155 or read head 175. As another example, spindle servo 180 may operate to rotate recording medium 160 so as to maintain a constant angular velocity with respect to surface 190, maintaining a constant rotational speed of recording medium 160 regardless of the location of write head 155 or read head 175.

Read head 175 is generally operable to read information from recording medium 160 and may comprise an optical scanner. While read head 175 is shown positioned below recording medium 160 for reading information from lower surface 190, it should be understood that read head 175 may be positioned to read information from an upper surface of recording medium 160. Like write head 155, read head 175 may be positioned by a movable carriage or arm so that read head 175 may be moved relative to surface 190. As an example, read head 175 may be movable to translate radially relative to a center of recording medium 160 or circumferentially around the center of recording medium 160. As an example, reading mechanism 170 may move read head 175 from an inner diameter of recording medium 160 to an outer diameter of recording medium 160 while read head 155 reads information from recording medium 160.

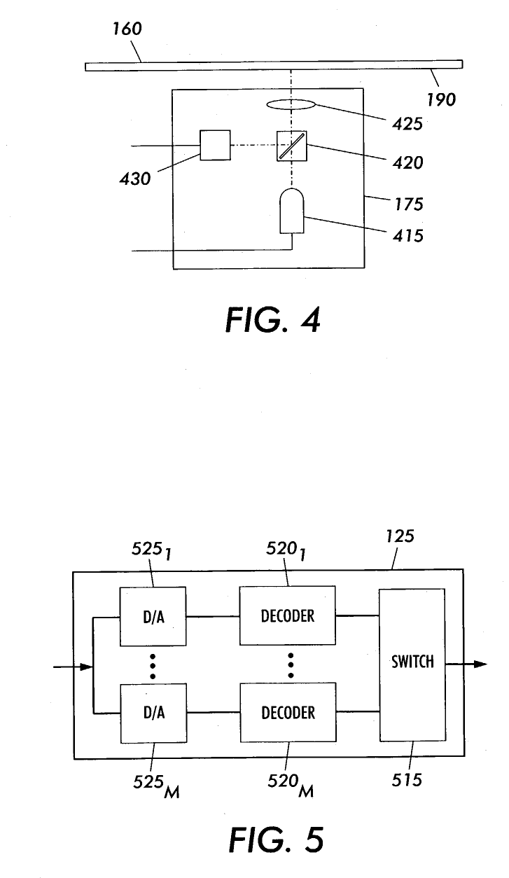

Referring to FIG. 4, read head 175 may include a radiation source 415, a beam splitter 420, a lens 425, and a detector 430. Radiation source 415 generally produces electromagnetic or photonic radiation, for example, a light beam. Radiation source 415 may be, for example, a laser diode or any other suitable source of electromagnetic or photonic radiation for reading information from recording medium 160. The intensity, frequency, or other characteristics of the radiation may be controlled by playback circuitry 120. The radiation is focused on recording medium 160 through beam splitter 420 and lens 425. The radiation is then reflected or otherwise modulated according to the characteristics of the portion of recording medium 160 that were altered during the recording of information. The modulated radiation travels through lens 425 and is directed to detector 430 by beam splitter 420. Detector 430 converts the modulated radiation to a signal which is conveyed to playback circuitry 120.

Returning to FIG. 1, playback circuitry 120 may include control circuitry for controlling radiation source 415 and detector 430 and circuitry for conditioning the signal from detector 430 for use by decoding circuitry 125. As such, like recording circuitry 115, playback circuitry 120 may include appropriate drivers, phase locked loop circuitry, amplifiers, level shifters, digital signal processors, microprocessors, analog to digital converters, digital to analog converters, memory, and various support circuitry.

Turning to FIG. 5, decoding circuitry 125 may include a switch 515, a number of decoders 520₁ . . . 520ₙ, and a number of digital to analog converters (D/A's) 525₁ . . . 525ₙ. Switch 515 generally operates as a de-multiplexer, switching the conditioned signal from playback circuitry 120 to one or more decoders 520₁ . . . 520ₙ. Decoders 520₁ . . . 520ₙ decode and/or decompress the conditioned signal from payback circuitry 120 from an encoded digital format, for example, MPEG-2, AVI, MOV, etc., to digital video and audio signals. D/A's 525₁ . . . 525ₙ generally convert the digital and audio signals to analog video and audio for use by one or more devices connected to outputs 130₁ . . . 130ₙ. In an embodiment where a device connected to outputs 130₁ . . . 130ₙ utilizes digital audio and video signals, D/A's 525₁ . . . 525ₙ may be bypassed and the digital video and audio signals may be provided directly to outputs 130₁ . . . 130ₙ.

Returning to FIG. 1, system controller 140 generally controls the operations and functions of system 100. In particular, and in accordance with the present invention, system controller 140 operates to control the operation of record servo 145, record mechanism 150, recording circuitry 115, recording device 155, playback servo 165, playback mechanism 170, playback circuitry 120, and playback device 175. System controller 140 has the capability to control each of these components independently of each other.

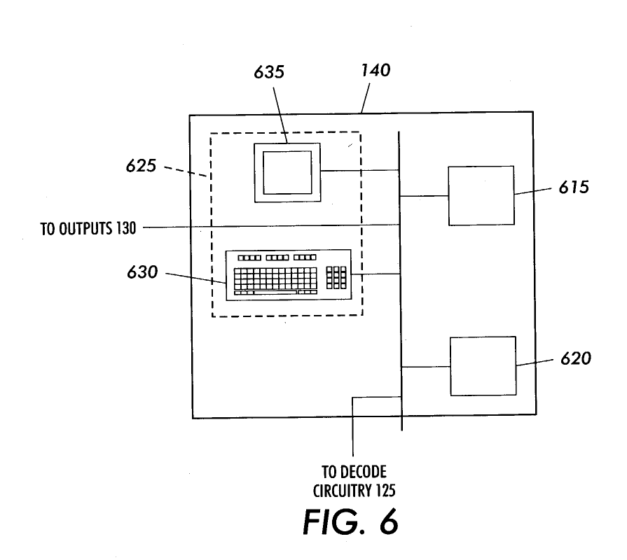

As shown in FIG. 6, system controller 140 may include a processor 615, a storage device 620, and a user interface 625.

Processor 615 is generally adapted to utilize machine readable program code stored in storage device 620 to control the operations and functions of system 100. Storage device 620 may include a storage media, for example, a magnetic media such as a diskette, or hard drive, an optical disk, read-only-memory (ROM), random access memory (RAM), semiconductor memory, or any combination of storage media. Storage device 620 may also be used to store encoded information from encoding circuitry 110 for processing or for buffering before being sent to write head 155. Storage device 620 may also store information from playback circuitry 120 before being sent to decode circuitry 125. This storing and buffering of information allows system controller 140 to perform various commands such as play slow, play fast, fast forward, instant replay, etc. mentioned below.

User interface 625 may include an input device 630 and a display device 635. Input device 630 provides a facility for receiving commands from a user and for accessing features of system 100. Input device 630 may comprise a number of buttons on a front panel, a keypad or keyboard, a remote control, or any appropriate device for providing user input to system 100.

Display device 635 may comprise a plasma screen, an LCD display, a CRT, or any device for providing directions, feedback, and information to a user regarding the operation of system 100. In one embodiment, user interface 625 may comprise devices connected to outputs 130₁ . . . 130ₙ, for example, a television, monitor, stereo, home theater, etc.

Commands a user may provide to system 100 generally include those commonly found on a VCR or DVD recorder, for example, record, play, play slow, play fast, pause, advance one frame, fast forward, rewind, instant replay, etc. Other commands may also be provided as described below.

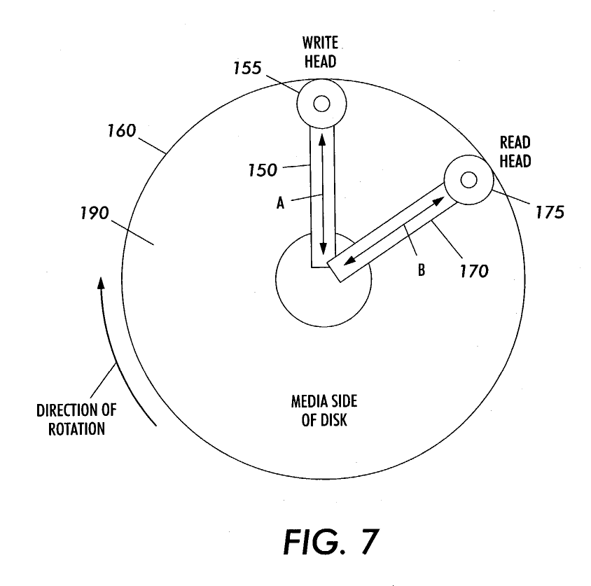

FIG. 7 shows record mechanism 150, write head 155, playback mechanism 170, read head 175, and their operation in more detail. Utilizing record mechanism 150 and playback mechanism 170, write head 155 and read head 175, respectively, are generally selectively and independently positionable along bottom surface 190 of media 160. In this embodiment, record mechanism 150 and playback mechanism 170 are carriages that transport write head 155 and read head 175 in linear directions as shown by arrows A and B, respectively. As such record mechanism 150 and playback mechanism 170 may include slides, bearings, belts, motors, and other drive mechanisms.

Under control of system controller 140 and record servo 145, record mechanism 150 may convey write head 155 radially across surface 190 of media 160, from the center of media 160 to a peripheral edge of media 160. In a similar fashion, under control of system controller 140 and playback servo 145, playback mechanism 170 may convey read head 175 radially across surface 190 of media 160, from the center of media 160 to a peripheral edge of media 160, in a direction different from that of write head 155. In the embodiment shown in FIG. 7, record mechanism 150 and playback mechanism 170 are positioned at an angle with respect to one another sufficient to allow write head 155 and read head 175 to access all portions of media 160 as media 160 rotates about spindle 187, selectively and independently, without contacting or otherwise interfering with each other.

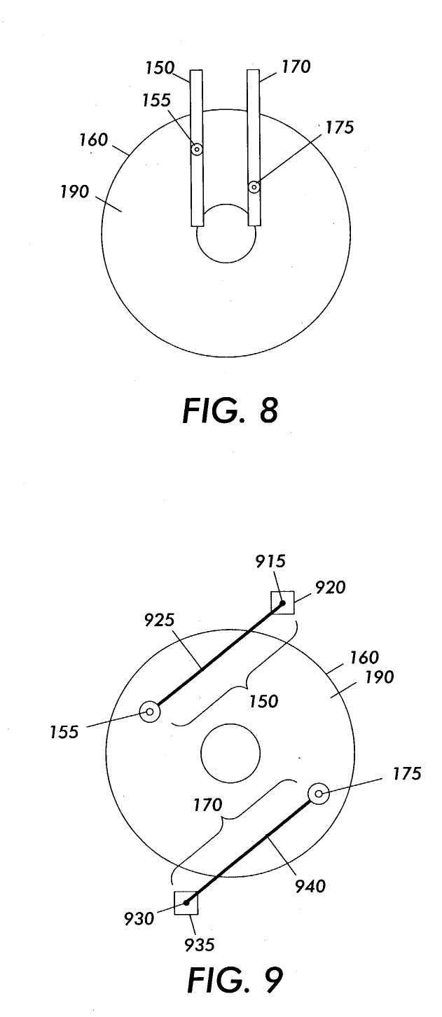

FIG. 8 shows another embodiment where record mechanism 150 and playback mechanism 170 are positioned parallel to each other, with enough clearance so that write head 155 and read head 175 may access all portions of media 160 independently, without interfering with each other.

In the embodiment shown in FIG. 9, record mechanism 150 includes a pivot 915, a pivot drive, and an arm 925 on which write head 155 is mounted. In a similar fashion, playback mechanism 170 also includes a pivot 930, a pivot drive 935, and an arm 940 on which read head is 175 is mounted. In this embodiment, pivot drives 920, 935 operate to rotate arms 925, 940 about pivots 915, 930, respectively. This causes write head 155 and read head 175 to traverse bottom surface 190 of media 160 along different circular paths. As in the embodiments shown in FIGS. 7 and 8, record mechanism 150 and playback mechanism 170 are positioned so that write head 155 and read head 175 may access all portions of media 160 independently and without interfering with each other. It should be understood that record and playback mechanisms 150, 170 may include any configuration and any number and/or type of components that allows write and read heads 155, 175 to be individually and independently positioned anywhere along a surface of media 160.

Because write head 155 and read head 175 are independently positionable along bottom surface 190 of media 160 according to the present invention, recording and playback functions may be controlled independently of each other, enabling features such as pause, review, fast forward, and time shifting of just recorded material.

Another feature enabled by the present invention is a “jump” feature. Write head 155 may record information in real time, while read head 175 may be enabled to jump to and read any portion of the recorded information simultaneously. For example, a user may utilize display 635 and input device 630 to program system 100 to record a video program from one or more inputs 105₁ . . . 105ₙ at a particular time. System controller 140 then controls the operations of system 100 such at the time specified, the program is encoded by encoding circuitry 110, processed by recording circuitry 115, and recorded on media 160 using write head 155. While write head 155 records the program, system controller 140 also operates record servo 145 and recording mechanism 150 to properly position write head 155 and operates spindle servo 180 to rotate media 160. After some amount of information has been recorded, for example, 1 hour of the program, the user may again utilize display 635 and input device 630 to jump to a particular portion of the program, for example, a portion commencing 6 minutes after recording started. In response, system controller 140 operates playback mechanism 170 to position read head 175 at the proper location and operates playback circuitry 120 and decoding circuitry 125 to playback the program through one or more outputs 130₁ . . . 130ₙ. After viewing the program for a desired time, the user may then provide input to cause a jump to a portion of the program commencing 30 minutes after recording began and system controller 140 may respond accordingly. The user may continue to jump to any other portion of the program and have that portion played back while write head 155 continues to record the program in real time.

A “tracking” feature may also be enabled, that is, read head 175 may be enabled to “track” write head 155, that is, to read data recorded by write head 155 at a fixed and selectable time interval corresponding to a portion of the information. For example, the user may utilize display 635 and input device 630 to playback a portion of the program commencing 5 minutes after recording began. System controller 140 continues to direct recording operations uninterrupted as described above, and proceeds to operate playback servo 165 and reading mechanism 170 to place read head 175 at the proper location, and to operate playback circuitry 120 and decoding circuitry 125 to provide the program to one or more of the outputs 130₁ . . . 130ₙ. System controller 140 then maintains the playback operations such that playback of the program continues at a fixed delay, in this example, 5 minutes. In other words, the user views the program at the same rate it was recorded, delayed by five minutes.

A “pause” feature may also be implemented where, during playback, upon a command from a user, system controller 140 operate playback servo 165 and playback mechanism 170 to cause read head 175 to repeatedly read a portion of the recorded information from media 160, for example, a single video frame. In another embodiment, system controller may implement the pause feature by storing an amount of information from read head 175 in storage device 620, and repeatedly reading the information from storage device 620. After a predetermined time period or upon another command, system controller 140 may then cause the playback of the program to resume from the point that the program was paused, at the same speed the program was recorded. In one example, when playback is resumed, read head 175 reads the recorded video program at a time delayed by the period of time between when read head 175 was paused and un-paused.

A “slow play” feature may also be implemented. As an example, a user may provide input to system 100 through input device 630 requesting slow playback of the recorded information. In response, system controller 140 may operate playback servo 165 and playback mechanism 170 to cause read head 175 to begin reading information from media 160 slower than it was recorded by write head 155.

System 100 may also provide “skip to real time” or “fast forward to real time” features. As an example of the skip to real time feature, after utilizing one or more of the jump, track, or pause features as described above, the user may utilize display 635 and input device 630 to program system 100 to skip to real time. In response, system controller 140 may simply route the signal from one or more inputs 105₁ . . . 105ₙ to one or more of the outputs 130₁ . . . 130ₙ. Alternately, system controller 140 may operate playback servo 165 and playback mechanism 170 to cause read head 175 to move to a position in close proximity to write head 155 and to read information immediately after it is recorded by write head 155. The information may then be conveyed through playback circuitry 120 and decoding circuitry 125 to one or more outputs 130₁ . . . 130ₙ.

As an example of the fast forward to real time feature, after making use of one or more of the jump, track, or pause features as described above, a user may provide input to system 100 through input device 630 requesting fast forward to real time. In response, system controller 140 may operate playback servo 165 and playback mechanism 170 to cause read head 175 to begin reading information from media 160 faster than it was recorded by write head 155. The reading speed may be predetermined, may be calculated by system controller 140, or may be set by the user. Upon catching up, or reaching “real time,” that is, upon reaching a point where the information is being read immediately after being recorded, for example, less than 1 second after being recorded, system controller 140 may operate playback servo 165 and playback mechanism 170 to cause read head 175 to read information from media 160 at the same speed at which it is being recorded by write head 155.

Thus, providing a system where write head 155 and read head 175 have access to all portions of media 160, selectively and independently, without interfering with each other, allows for the provision of features such as pause, review, fast forward, and time shifting of recorded material. In addition, enhanced features may be provided including skip to real time and fast forward to real time.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A recording device comprising:
a write head adapted to record an electronic data stream on a recording medium; and
a read head adapted to read the electronic data stream from the recording, medium, wherein the read head is selectively and independently positionable on the recording medium relative to the write head.

2. The recording device according to claim 1, wherein, the read head is adapted to selectively read previously recorded portions of the electronic data stream from the recording medium simultaneously while the write head records the electronic data stream on the recording medium in real time.

3. The recording device according to claim 1 wherein the recording medium is a rotating optical disk.

4. The recording device of claim 1 wherein the recording medium is a rotating magnetic disk.

5. The recording device according to claim 1 wherein the read head is adapted to track the write head at a fixed and selectable time interval corresponding to a portion of the electronic data stream.

6. The recording device according to claim 1 wherein the read head is adapted to track the write head until the read head is paused, and wherein the read head is adapted to read and output a signal corresponding to an end portion of the electronic data stream recorded at the time the read head was paused.

7. The recording device according to claim 6 wherein the read head is adapted to track the write head when the read head is un-paused.

8. The recording device according to claim 6 wherein the read head is adapted to track the write head when the read head is un-paused, and wherein the read head is adapted to read and output a signal corresponding to the video stream recorded but delayed by the period of time between when the read head was paused and when the read head was un-paused.

9. The recording device according to claim 6 wherein the read head is adapted to catch up or skip to and track the write head when the read head is un-paused.

10. The recording device according to claim 6 wherein the read head is adapted to catch up to and track the write head when the read head is un-paused, and wherein the read head is adapted to read and output at a rate faster than the rate at which the electronic data stream was received for recording a signal corresponding to the electronic data stream starting at the time the read head was paused and ending at the time the read head substantially catches up to the write head.

11. The recording device according to claim 1, wherein the read head is selectively and independently positioned on the recording medium relative to the write head for reading a first part of the recording medium when the write head is recording on a second part of the recording medium different from the first part.

12. The recording device according to claim 1, wherein the read head is selectively and independently positioned on the recording medium relative to the write head for pausing at a first part of the recording medium when the write head is recording on a second part of the recording medium different from the first part.

13. A recording device adapted to record an input signal as electronic data on a rotating disk, the recording device comprising:
a first positioning drive;
a write head coupled to the first positioning drive;
a second positioning drive independently positionable relative to the first positioning drive; and
a read head coupled to the second positioning drive, wherein, the read head is adapted to read data from the rotating disk simultaneously while the write head writes new data to the optical disk, and wherein the second positioning device may selectively position the read head independent of the write head.

14. The recording device according to claim 13 wherein the read head is adapted to track and read data written by the write head at a selectable delayed time interval from when the data was written to when the data is read.

15. The recording device according to claim 13 wherein the read head is adapted to read data at a rate faster than the rate at which the data was written.

16. The recording device according to claim 13 wherein the read head is adapted to read data corresponding to an end of a data portion written at the time the read head is paused.

17. The recording device according to claim 16 wherein the read head is adapted to read the data portion written when the read head was paused simultaneously with the write head writing a new data portion of the rotating disk.

18. The recording device according to claim 16 wherein the read head is adapted to read, at a rate faster than the rate the data was written, a data portion written starting at the time the read head was paused and ending at the time when the read head substantially corresponds to data being written.

19. A method of recording and playing an electronic data stream comprising:
writing data corresponding to the electronic data stream to a disk with a write head in substantially real time;
following the write head with a read head being independently positionable relative to the write head; and
selectively reading previously recorded portions of the electronic data stream with the read head simultaneously with the write head continuing to write data corresponding to the electronic data stream to the optical disk in substantially real time.

20. The method of recording a electronic data stream according to claim 19 further comprising the step of outputting data read by the read head at a rate substantially the same as the rate of the data being written.

21. The method of recording an electronic data stream according to claim 19 wherein selectively reading comprises reading data with the read head at a rate slower than the rate of the data being written.

22. The method of recording an electronic data stream according to claim 19 wherein selectively reading comprises reading data with the read head at a rate faster than the rate of the data being written.

23. The method of recording an electronic data stream of claim 19 further comprising the step of repeatedly outputting data read by the read head corresponding to the data written during a fixed time where the read head is paused.

24. The method of recording an electronic data stream of claim 19 wherein selectively recording comprises skipping at least one previously recorded portion.
